(19) United States
(12) Patent Application Publication
(10) Pub. No.: US 2025/0219739 A1
(43) Pub. Date: Jul. 3, 2025

(54) RECONFIGURABLE DEFRAMER FOR OPTICAL COMMUNICATIONS

(71) Applicant: Intel Corporation, Santa Clara, CA (US)

(72) Inventors: Sundar Krishnamurthy, Dublin, CA (US); Deepak Dasalukunte, Beaverton, OR (US); Conor O'Keeffe, Cork (IE); Finbarr O'Regan, Innishannon (IE); Paulino Mendoza, Zapopan (MX); Vesh Raj Sharma Banjade, Portland, OR (US); Daniel Zeleznikar, Strongsville, OH (US)

(21) Appl. No.: 18/397,214

(22) Filed: Dec. 27, 2023

(51) Int. Cl. H04B 10/61

(52) U.S. Cl. CPC H04B 10/613; H04B 10/6165

(57) ABSTRACT

A system includes a first chiplet that includes at least one demodulator for demodulating at least one received signal from a receiver to generate hard bits and soft information from the received signal and a second chiplet coupled to exchange information with the first chiplet. The second chiplet includes at least one correlator to detect a symbol pattern indicating frame boundaries of frames having a known frame symbol period length in an acquisition state and transitioning the first and second chiplets to a connected state in response to a threshold number of successful frame boundary detections. The at least one correlator uses soft bit representations to correlate and deduce the frame boundaries in a windowed mode using the known frame length and previous frame boundary information while in the connected state and transitions the first and second chiplets out of the connected state and back to the acquisition state in response to at least one unsuccessful frame boundary detection.

### BACKGROUND

Deframing is one of the most important functionalities in coherent optical transceivers, that enables initial acquisition, frame synchronization, and tracking of dual polarization mapping. Deframing in optical receivers is performed following demodulation of a received optical signal into a bitstream. Deframing identifies frame boundaries and help map bits to corresponding frame indices. Deframing for terrestrial fiber optic transceivers are designed based on a fixed frame structure from a specific standard like OpenZR+ or 400ZR. Since these standards handle only dual polarization signals, deframing may be hardened in a system on chip (SoC) considering the specific frame structure and nature of the waveform. Deframing used in existing optical inter-satellite links (OISL) are typically for single polarization and are custom designed for specific frame structures and tailored to mission goals. A reconfigurable deframer catering to wide range of terrestrial and satellite coherent optical standards has not been designed before.

### BRIEF DESCRIPTION OF THE DRAWINGS

FIG. 1 is a simplified block diagram of an improved reconfigurable deframing system according to an example embodiment.

FIG. 2 is a detailed block architecture diagram of a deframer system according to an example embodiment.

FIG. 3 is a lookup table for determining frame boundaries according to an example embodiment.

FIG. 4 is a state diagram showing an initial SYNC state and connected COMM state in the context of an OpenZR standard according to an example embodiment.

FIG. 5 is a state diagram showing an initial SYNC state and connected COMM state in the context of an LCRD standard according to an example embodiment.

FIG. 6 is a state diagram showing an initial SYNC state and connected COMM state in the context of an SDA standard according to an example embodiment.

FIG. 7 is a block architecture drawing of a reconfigurable deframer system that can handle both single and dual polarization waveforms according to an example embodiment.

FIG. 8 is a block diagram of an example deframer having a correlation peak table in the initial acquisition mode according to an example embodiment.

FIG. 9 illustrates an OpenZR subframe structure used to perform cycle slip correction to correct for phase discontinuity according to an example embodiment.

FIG. 10 is a flowchart illustrating a method of deframing symbols according to an example embodiment.

FIG. 11 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

To design a reconfigurable transceiver for supporting numerous standards used for optical inter satellite communication, a universal highly reconfigurable deframer is needed that can handle various frame structures. High reconfigurability is essential owing to the limited SWaP-C constraints (Size, Weight, Power and Cost) in satellite systems which cannot host and power complex systems. Further, such links are prone to dynamic pointing induced fading due to mis alignments of the optical apertures arising from satellite jitter. Such fading causes SNR fluctuations that make frame synchronization challenging, and techniques such as combining correlation outputs from multiple frames and flywheeling would be necessary.

Terrestrial fiber optic transceivers are typically designed based on OpenZR+ standard or 400ZR standard only for dual polarization signals in continuous mode with modulation schemes such as QPSK, 8PSK, 16QAM. Baud rates are typically high around 30 or 60 GBaud to support data links of 100 Gbps or higher up to 800 Gbps. In standards used for Lunar Communication Relay Demonstration (LCRD) and Space Development Agency (SDA), fixed preamble length of 120 and 64 bits are used respectively, to help achieve frame synchronization with single polarization waveforms. LCRD and SDA transceivers designed by NASA and Space development agency are typically analog in nature with direct detection receivers covering only DPSK and OOK waveforms. Deframing functionalities in OpenZR transceivers are designed only for dual polarization continuous mode waveforms catering to QPSK, 8PSK, 16QAM modulation schemes, which is very restrictive for satellite links. Further, satellite impairments such as pointing induced fading are not considered in previous solutions, especially in the context of OpenZR/400ZR transceivers.

Coherent optical modems used in terrestrial fiber optic systems differ significantly from those used in optical inter-satellite links (OISL). Different inter-satellite links between LEO and GEO satellites experience varying channel impairments such as Doppler, sampling clock offset and dynamic pointing induced fading. These are primarily impacted by the relative motion of the satellites, range of the link, nature and dimensions of the optical apertures. Dynamic pointing induced fading arise due to misalignment of the transmit and receiver apertures and is a significant impairment in various DSP functionalities. Deframing circuitry responsible for initial acquisition, frame synchronization and tracking of dual polarization mapping need to be very robust to such pointing induced fading.

Terrestrial fiber optic transceivers designed by commercial organizations based on OpenZR+ or 400ZR standard cannot be repurposed for satellite links since the channel model is significantly different. Also, there was never a need to support single polarization waveform or burst mode of operation. In these designs, baud rates were fixed roughly as 30 Gbaud or 60 Gbaud to support links with data rates of 100 G, 200 G or 400 G. Therefore, deframing circuits were fixed designs catering only to a restrictive set of requirements. On the other hand, LCRD and SDA transceivers designed by government entities are typically designed for DPSK waveform at 2.88 Gbaud and OOK waveform at 2.5 Gbaud respectively. These are single polarization waveforms with burst mode of operation and analog design was used to build such transceivers in the last decade by NASA and SDA. Direct detection OOK or PPM receivers were used and deframing was hardened based on the specific usecase. Reconfigurable deframing with robustness to fading is therefore a unique fundamental requirement in SpaceBACN and future coherent optical modems targeted for inter-satellite links and beyond.

Framing and Deframing functionalities vary depending on the optical standards used such as OpenZR, LCRD, SDA, CCSDS and so on. Standards like OpenZR and ZR400 involve dual polarization waveforms and therefore deframing involves tracking of dual polarization mapping apart from frame synchronization. Additionally, cycle slip correction would be necessary to handle phase discontinuities due to the non-differential nature of the modulation scheme. Standards like LCRD, SDA involve only single polarization waveforms with simple preamble sequence, hence deframing primarily deals with frame synchronization. Owing to the reconfigurability requirement, a single frame correlator needs to cater to varying standards and preamble lengths in the case if LCRD-SDA deframer. In the case of LCRD, waveforms which can also be received in a burst mode, frame boundary information is shared with various DSP circuitry to enable gating of the received signal as appropriate.

Performance of deframers in terms of frame boundary detection is crucial for the modem performance, especially in fading environment like in optical inter-satellite links due to jitter. While the Pre-FEC bit error rates (BER) could be reasonable, improper frame synchronization could affect the post-FEC BER.

A highly reconfigurable deframer for a coherent optical transceiver is reconfigurable with respect to frame size and can be reconfigured to support single and dual polarization waveforms, both continuous and burst mode waveforms, baud rates of 1-33 GBaud, and frame structures from different standards like terrestrial fiber optic standard OpenZR+, standard for Lunar Communication Relay Demonstration (LCRD) and standards developed by Space Development Agency (SDA) covering LEO-LEO and LEO-GEO inter-satellite links. Such a highly reconfigurable optical transceiver targeting widely varying system requirements has not been designed before.

The improved deframer circuit can be robust against fading as needed in optical inter-satellite communication. It can perform initial acquisition, frame synchronization and polarization mapping identification along with cycle slip correction, while meeting the low SWaP-C goals and can be used in other coherent optical modems meeting the system requirements.

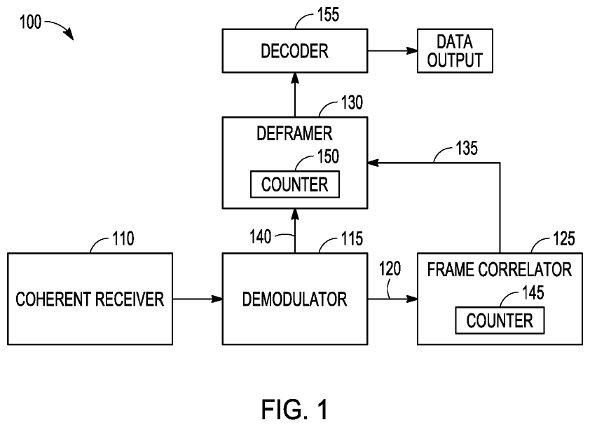

FIG. 1 is a simplified block diagram of an improved reconfigurable deframing system 100 for deframing received digital signals derived from a coherent receiver 110 that receives optical signals. System 100 may also be thought of as a modem for converting the demodulated received signals into data that was encoded in the received optical signals.

A demodulator 115 is coupled to receive signals based on a selected one of many different standards having different waveforms, baud rates, modulation schemes, frame structures and other differences. Demodulator 115 converts the received optical signals to symbols, such as digital ones and zeros on line 120 in accordance with the selected standard or other data transfer protocol, which may or may not be an industry standard.

The symbols are provided on line 120 to a frame correlator 125. In one example, the frame correlator 125 is provided information regarding the protocol, such as frame length and training sequences of data. In further examples the frame correlator 125 may include multiple correlators for protocols having dual polarization signals. The frame correlator 125 in one example, utilizes its knowledge of the frame boundaries to perform detection. Successful detection of a consecutive number, such as three or more, of frame boundaries in the training sequence performed in a detection mode will result in transition to a connected mode.

Once in the connected mode, a deframer 130 receives, via line 135 frame boundary identification from the frame correlator 125 and also receives the symbols via line 140 from the demodulator 115. The deframer 130 also has knowledge of the frame size. Counters 145, 150 are used in both the frame correlator 125 and deframer 130 to synchronize the counting of symbols within a frame or subframe in some examples. The counter 145 shares its count with counter 150 to perform such synchronization. The counters 145 and 150 are reset at the end of each frame or subframe.

The deframer 130 identifies bits in each frame or subframe and passes the bits to a decoder 155, which provides data out 160 corresponding to encoded data received via the coherent receiver 110.

In one example, the frame correlator 125 continues to detect frame boundaries while the deframer 130 operates in the connected state. In response to the frame correlator 125 not successfully detecting frame boundaries, system 100 may transition back to acquisition mode until the consecutive number of frames are successfully detected again, resulting in a transition back to the connected mode.

### Deframer Architecture

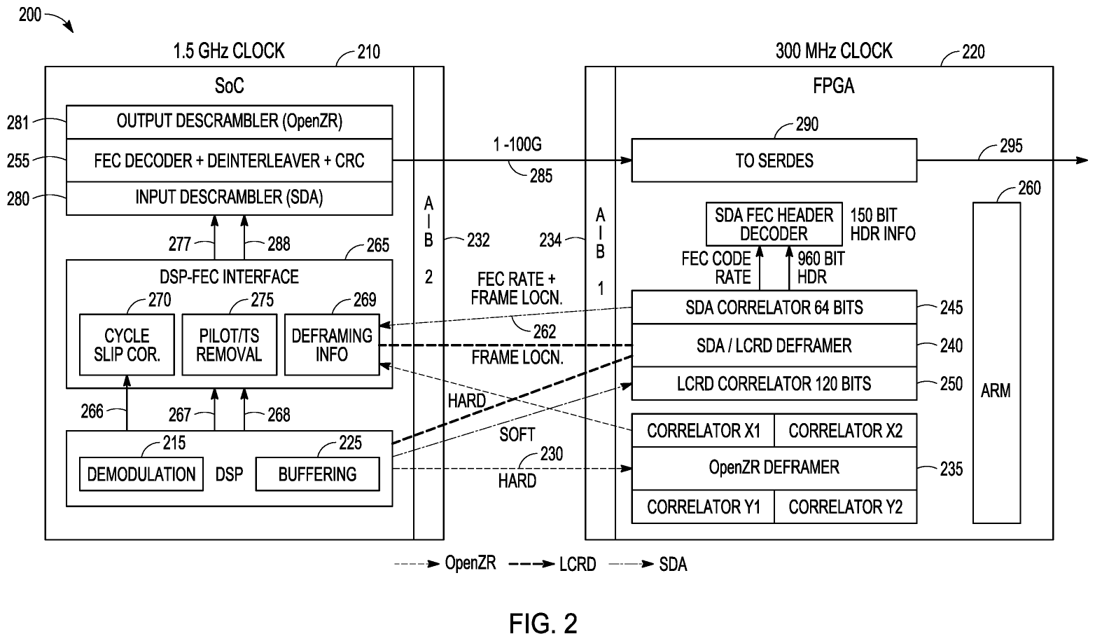

FIG. 2 is a detailed block architecture diagram of a deframer system 200 that includes first chip or chiplet 210 provides selected digital signal processor (DSP) functions. A chiplet is basically a semiconductor chip that is not individually packaged. Chiplets can be connected together to perform various functions.

Chiplet 210 may be a System on Chip (SoC) or DSP/FEC (forward error correction) chiplet with demodulation 215 being the last receiver function before a deframer chiplet 220 performs other functions. In one example deframer chiplet 220 is a field programmable gate array (FPGA) chiplet 220. Soft LLR (Log Likelihood Ratio—a probabilistic identification of a symbol or bit) is stored in buffers 225 of chiplet 210 and hard bits 230 are deduced from the sign of the Soft LLR. This soft or hard information is passed to the deframer in the FPGA via Advanced Interconnect Bus (AIB) shown in each chip respectively at 232 and 234. The AIB 232, 234 transfers data between the chiplets 210 and 220, which may operate at different clock rates, e.g., 1.5 GHz and 300 MHz respectively.

An OpenZR deframer 235 in the FPGA chiplet 220 mainly comprises of four correlators, X1, X2, Y1, Y2 to correlate the soft LLR or hard bits with frame alignment or training sequences defined on 2 polarizations. The deframer 235 correlators X1, X2, Y1, Y2 help identify both a polarization mapping index as well as a frame boundary for the signal in each of two polarizations used in OpenZR. In case of single polarization waveforms, only one of the 4 correlators maybe enabled to calculate just the frame boundary. Each of the correlators include a 1-bit hard correlator for initial acquisition state and another 4-6 bit soft bit correlator for connected state. These correlators can be configured to enable OpenZR using the 11 symbol training sequence in the connected state and an additional 22 symbol frame alignment word (FAW) for correlation in the initial acquisition state. Since these OpenZR sequences are short, correlator output for the training sequence from multiple OpenZR subframes (e.g., 3-5) could be combined in both acquisition and connected states, to improve synchronization performance. Frame boundary could be identified as the index ‘j’ that maximizes the correlation output, shown below using the most generic form of a correlator.

$$f ( s , y ) = C ( j ) = {\sum }_{i = 0}^{10} s ( i ) y ( i + j )$$

Wherein s(i) refers to the i-th symbol in the training sequence, y refers to the received signal and index i is used to sweep the training sequence length of 11. Instead of maximizing correlator output, a triangle detection could be performed to deduce the frame boundaries with suitable peak and side thresholds to improve performance in noisy conditions.

In the OpenZR Correlators X1, X2, Y1, Y2: 1,2 refer to the polarization index of received signal whereas X,Y refer to the X and Y polarization sequences defined in the standard. Correlation outputs are paired and added to identify the polarization mapping indices as follows:

$$C ( X 1 ) + C ( Y 2 ) > C ( X 2 ) + C ( Y 1 ) then Pol = \{ 1 , 2 \} , else Pol = \{ 2 , 1 \}$$

Polarization map of {1,2} and {2,1} is fed from the FPGA chiplet to the DSP-FEC chiplet along with frame boundaries for further processing.

An SDA and LCRD standard deframer 240 uses either SDA correlator 245 or LCRD correlator 250 which are used only to identify the frame boundary for signals received in the respective standards. Keeping the correlators in deframers 235 and 240 in the FPGA chiplet 220 allows high reconfigurability for supporting numerous frame structures and frame, preamble or training sequence lengths, enabling to extend beyond SDA, LCRD standards.

Deframer 240 SDA correlator 245 and LCRD correlator 250 are single correlators that can be configured up to 128 bits (120 bits for LCRD and 64 bit for SDA). An SDA header of roughly 960 bits is subsequently sent to an SDA FEC (forward error correction) header decoder 255 which decodes the 160 bit header and forwards to processor cores 260. Frame boundary and FEC payload coding rate are sent to the DSP-FEC interface via 262 in the SoC. Each of the correlator would comprise of a 1-bit hard correlator and a soft bit correlator for processing 4-6 bits of soft information. Hard bit correlators are used during initial frame synchronization or acquisition mode, also referred to as a SYNC state, while soft bit correlators employing an Approximate Massey algorithm or other variant may be used in the connected or COMM state.

Within the SoC chipset 210 a DSP-FEC interface 265 receives the demodulated signal at 266, the soft LLR at 267, and the hard bit 268 information. The soft LLR information is buffered for a programmable duration of few frames or sub-frames. Once frame boundary information, shown as deframing information 269, is received from the FPGA chiplet 220, cycle slip correction 270 is performed in the case of OpenZR standard to correct phase rotations and remove any phase discontinuities. Then, pilot and training sequences and other header bits are removed at 275, and payload and parity bits are forwarded to the Forward error correction (FEC) decoder 255 at 277 and 278. A Bit error rate (BER) calculator can estimate BER using the received bitstream and the known training or pilot sequences before 275 to quantify Modem BER performance. Descrambler 280, 281 could process the payload first especially if located outside the FEC. De-interleaving, FEC decoding and CRC checks are performed as part of the FEC decoder 255. Output descrambling maybe performed in the case of OpenZR following which, bitstream is sent back at 285 to the FPGA chiplet 220 for SERDES (serialization/deserialization) interface 290 to provide a decoded output at 295.

In one example, deframer 235 only uses hard bits in the initial acquisition mode and soft LLR in the connected mode. Deframer 235 operates in continuous correlation mode generating output in every symbol during initial acquisition and in a windowed correlation mode in the connected state.

In another example, when using burst mode waveforms, deframer 235 passes the frame boundary and polarization mapping for dual polarization to various DSP chipset 210 circuitry to gate the functionality on or off as appropriate. This gating enables error free receiver processing due to low signal to noise ration (SNR) in dead time based on the duty cycle of the waveform. This is especially useful for LCRD burst mode waveform using a DPSK modulation scheme with duty cycle of 50%, 25% and so on . . . .

The hard bit correlators or deframer 235 are used with correlator output generated for every received symbol position. This involves just low complexity bitxor operations with the preamble or the frame alignment sequence. It would not be feasible to send soft LLR in initial acquisition state due to the high bandwidth needed as correlation is performed continuously over every received symbol. Since bitxor counts the number of bits that differ, minimizing the sum of bitxor output for various offsets can help in achieving frame synchronization.

For dual polarization OpenZR waveforms, the correlators X1, X2, Y1, Y2 are used to perform bitxor with 2 preamble or frame alignment word (FAW) sequences with bitstream on 2 polarizations to deduce both the frame boundary and the polarization mapping indices.

For single polarization LCRD/SDA waveforms single correlators are used to perform bitxor with single preamble sequence with bitstream in single polarization to deduce the frame boundary.

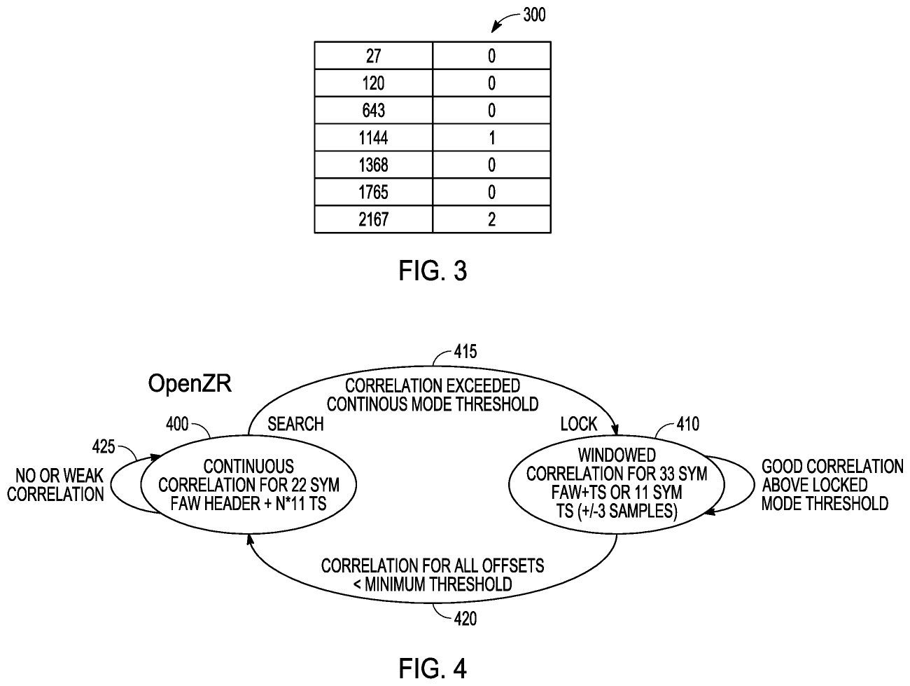

Bitxor operations are simpler in hardware circuits and an adder tree could help in accumulating the correlator outputs with hard bit operations. FIG. 3 is a lookup table 300 for determining frame boundaries by combining correlator outputs to enable initial acquisition.

Frame boundary detection may utilize lookup table 300 in a lookup table-based approach wherein multiple frame boundaries are detected to establish initial link acquisition. Peak threshold and two side thresholds are defined to detect a triangle corresponding to frame boundary detection, termed as frame boundary candidate. Each frame boundary candidate has its correlation value above peak threshold and at least two consecutive correlation values below side thresholds. This is because sequences are typically pseudo-random PN (pseudo random noise) sequences which exhibit high auto-correlation at the optimal time instant and low cross-correlation with non-zero offsets. Every frame boundary candidate is stored in the lookup table (LUT) 300 along with a frame counter which is initially set to 0.

When new frame boundary candidates are detected, a previous frame boundary candidate is searched in the LUT 300 with a programmable uncertainty window length. A new frame boundary candidate is stored with an incremented frame counter if the previous frame boundary candidate is found. A new frame boundary candidate is stored with the current frame counter value if previous frame boundary candidate is not found. Previous frame boundary candidate is searched using the current frame boundary candidate by subtracting the known frame length for specific standard and considering +/− uncertainty window length to account for timing drifts.

Initial acquisition is deemed to be complete when L consecutive frame boundary candidates get populated in the LUT 300 with the frame counter value reaching L for any of the entries, after which system 200 is switched from SYNC or acquisition state state to COMM or connected state. If the frame counter value is less than L for all entries in the LUT 300, new entries are populated as and when frame boundary candidates are generated.

Table 300 illustrates the initial acquisition process with frame length assumption of 1024 and frame boundary candidates generated at symbols 27, 120, 643, 1144, 1368, 1765, 2167 . . . . When entry for frame boundary candidate 1144 is made, 1144−1024=120 would be found in the table 300, hence the frame boundary counter is incremented as 1. Similarly, 2167 would also have frame boundary counter incremented due to an uncertainty window considered on top of 1024 frame length. Since 3 consecutive frame boundaries are detected, 2167 is when the Modem would move from acquisition state to connected state.

The initial acquisition is performed using multiple frame boundary detection to reduce the false alarm probability. LUT 300 size is determined based on the preamble length and baud rate and could be extended if necessary. Once 3 or L consecutive frame boundaries are detected, LUT 300 memory is cleared before moving the system 200 to the connected state.

In the connected state, soft bit correlators may be used with additions of soft LLR with a programmable uncertainty window to identify the frame boundary in the connected or COMM state. Note that these correlators are engaged only periodically based on the known standard specific frame length, to identify frame boundary within the uncertainty window. Since soft LLR information is typically 4 to 6 bits and correlators are in the FPGA for reconfigurability, periodic correlation becomes necessary in connected state to control the bandwidth for data transfer across chiplets. Soft LLR correlation is important in the connected state to achieve high frame synchronization performance which is not achievable with 1-bit hard correlators.

In one aspect, soft correlation is performed in the connected state by using the sign of the preamble, frame alignment word (FAW) or training sequences. Below is an example equation corresponding to a soft correlator wherein s(i) represents the preamble or FAW sequence while y(i+j) represents the soft LLR at an offset j. In this example, 11 symbol accumulator is shown for the correlator output, but could vary depending on the frame structure and standard. This can be implemented using switches for checking the sign and using suitable adders to accumulate the soft LLR correlation output.

$$f ( s , y ) = C ( j ) = {\sum }_{i = 0}^{10} \{ sign ( real ( s ( i ) ) ) real ( y ( i + j ) ) + sign ( imag ( s ( i ) ) ) i m a g ( y ( i + j ) )$$

$${\sum }_{i = 0}^{10} sign ( real ( s ( i ) ) ) real ( y ( i + j ) ) + sign ( imag ( s ( i ) ) ) i m a g ( y ( i + j ) )$$

In another aspect, a Massey algorithm or approximate Massey algorithm or its variant is used to calculate the frame boundary using the soft LLR information. Massey algorithm could be using the following metric

$$f ( s , y ) = s y - \frac{N}{2 \sqrt{E}} log cosh ( \frac{2 y \sqrt{E}}{N} )$$

where s is the preamble sequence, y is the soft LLR based on the received signal, E is the symbol amplitude and N is the one-sided noise spectral density. Correlation index ‘i’ and real/imaginary components are omitted for brevity.

$$f ( s , y ) = \{ \begin{matrix}0 & if sign ( y ) = s \\ - \vert y \vert & otherwise\end{matrix}$$

In another example, simpler approximate Massey algorithm that is more suitable for hardware implementation could be chosen as shown above. Soft decision-based frame synchronization using Approximate Massey algorithm may have circuitry for checking the sign and taking the absolute value and a summation to generate the correlator output corresponding to the length of the frame alignment word (FAW) or the training sequence. Sign of real and imaginary components in the signal are individually compared against training sequence and absolute values are used to calculate the correlation output.

### Deframer Functional Flow

FIG. 4 is a state diagram showing the system 200 in initial SYNC state 400 and connected COMM state 410 in the context of OpenZR standard. The terms mode and state are used interchangeably while discussing state diagrams. In the initial acquisition state, continuous correlation is performed in every symbol period based on the frame alignment word (FAW) and the training sequence. Once the system 200 moves to connected state 410, windowed correlation using the training sequence is performed for every subframe. In both states, correlator outputs from several previous frame boundaries are combined to deduce the current frame boundary since OpenZR training and frame alignment sequences are quite short i.e., 11 and 22 symbols. When the correlation output exceeds the continuous mode threshold shown at 415, the system 200 is switched from the SYNC state 400 to the COMM state 410 with a certain programmable value for the threshold. When in the COMM state 410, if correlation outputs for all offsets are below a programmable minimum threshold at 420, the system 200 is switched back from the COMM state 410 to SYNC state 400. In the initial SYNC mode or state 400, no or weak correlation 426 would imply that the system 200 remain in the same state. Similarly, if the connected state correlation output is above a certain threshold, Modem would remain in the connected state.

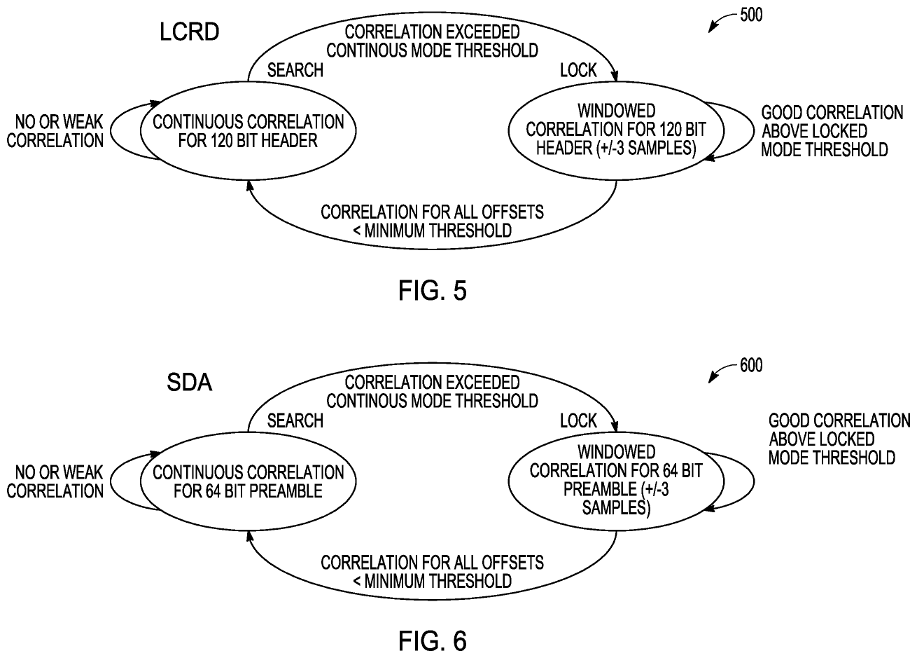

FIGS. 5 and 6 are corresponding state diagrams 500 and 600 for the LCRD and SDA standards wherein 120 or 64 bit preamble sequences are used to identify the frame boundary, respectively. State transitions remain the same, and because of having the circuitry in the FPGA chiplet 220, frame length, correlation window length are programmed as necessary.

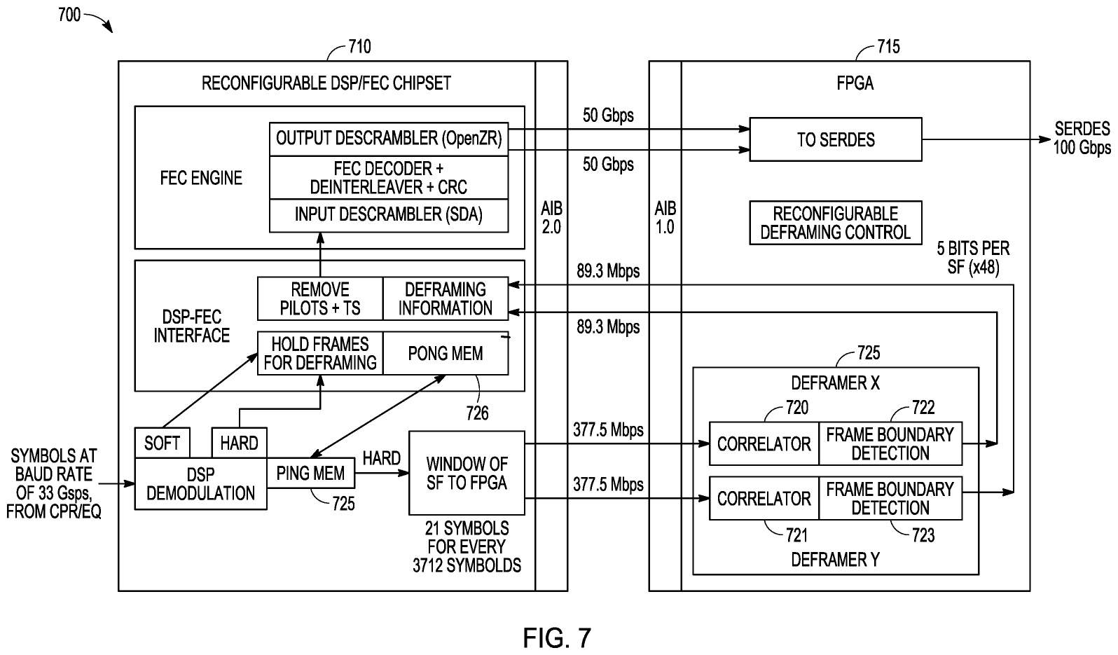

FIG. 7 is a block architecture drawing of a reconfigurable deframer system 700 that can handle both single and dual polarization waveforms. System 700 includes a reconfigurable DSP chiplet 710 and an FPGA chiplet 715. Separate correlators 720, 721 and frame boundary detection 722, 723 are shown in a deframer 725, though it could be repurposed. Frame boundary is detected along with a polarization mapping index which are then fed back to the DSP chiplet 710. Within the DSP chiplet 710, buffered soft decisions are used to perform cycle slip correction and various header fields such as pilot and training sequences are removed from the frame or subframe. Ping-pong memory 725, 726 could be used to store the soft information buffered in the DSP chiplet 710 corresponding to a subframe duration.

In one example, correlation outputs in the connected state are stored in a table defined for the uncertainty window size and added or combined with future correlation values to reduce the frame boundary mis-detection performance. This is triggered based on a programmable moderate or low SNR threshold along with number of consecutive frame boundaries to combine. Weighting functions could be used additionally that include scaling the correlator outputs by a function of the measured Modem SNR before combining multiple of them. This correlator output combining mechanism also helps in improving robustness against pointing induced fading.

In another example, frame boundary and polarization mapping indices are stored in memory corresponding to last time when deframer calculated SNR was high. Part of deframing is avoided for subsequent frames at low SNR since that could lead to erroneous frame boundary detection. This flywheel mechanism could be based on a programmable threshold for SNR and a time duration of flywheel mode. Whenever high SNR is obtained again, deframing operations are switched on to enable new frame boundary detection. Only when Modem performance is not satisfactory, i.e., at least one of low SNR and high measured BER, such flywheeling could be enabled, otherwise combining multiple correlator output tables may be sufficient. This mechanism provides high robustness against deep fades due to pointing induced fading.

LCRD includes a single 120 bit preamble sequence and therefore, frame boundary detection could be single shot and independent. Since SDA includes 64 bit preamble, correlation outputs from at least 2 consecutive frame boundary detection could be combined to improve synchronization performance. In the case of OpenZR, since the frame alignment word (FAW) is only 22 symbols and the training sequence is only 11 symbols, correlator outputs from 3-6 consecutive frame boundary detection could be combined to perform robust frame synchronization in the presence of fading. More generally, correlator outputs from a programmable number of frame boundary detection would be combined to support evolving satellite standards, to mitigate effects of satellite jitter and pointing induced fading.

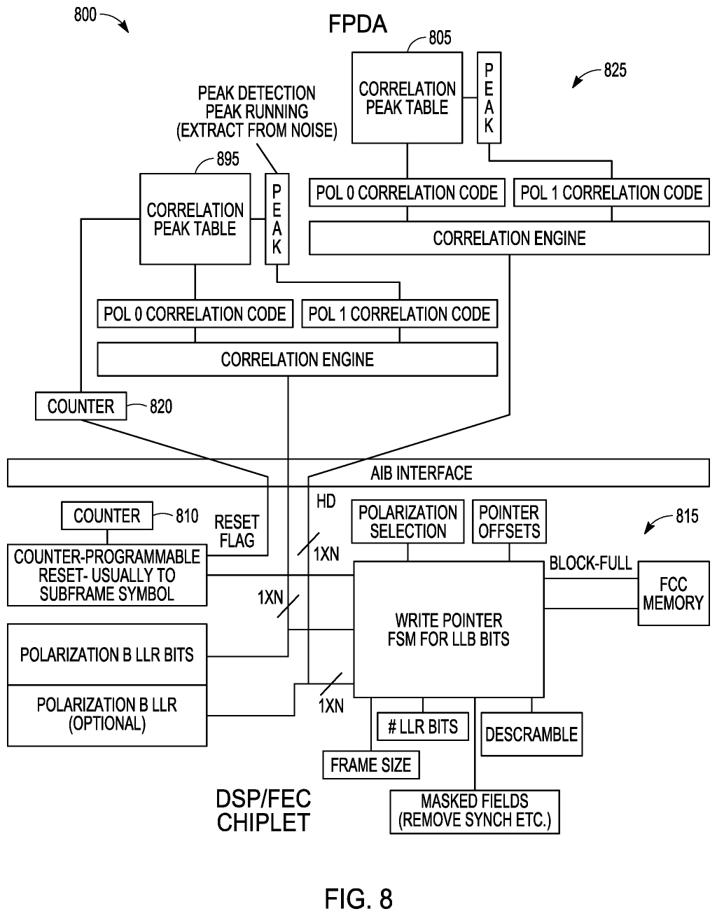

FIG. 8 is a block diagram of an example deframer 800 having a correlation peak table 805 in the initial acquisition mode. A counter 810 is maintained in a DSP/FEC chiplet 815 and its mirror image ‘counter’ 820 is maintained in an FPGA chipset 825 with appropriate reset procedures for synchronizing the counter values. The counter value serves as a relative reference for frame boundary using which all correlation and buffer read or write operations could be defined. Pointer offsets denote the relative frame boundary offset across the two polarizations and polarization selection helps in mapping the dual polarizations.

### Cycle Slip Correction

Cycle slips arise in coherent optical receivers for non-differential PSK (phase shift key) modulation schemes especially when feed-forward phase recovery method like Viterbi-Viterbi is performed with phase unwrapping. Such phase unwrapping step adds multiples of π/2 to the estimates generated by the phase recovery algorithm so that the phase difference between two consecutive estimates is always less than a certain threshold. Since phase unwrapping is also error prone, especially with significant white noise (AWGN) or phase noise, incorrect multiples of π/2 are added to phase estimates causing erroneous constellation rotations. Therefore, cycle slip correction is a necessary functionality to avoid catastrophic error bursts due to phase rotations of such incorrect multiples of π/2 in the signal.

In one example, cycle slip correction is performed after frame boundary detection in every subframe using a three step method: 1. Phase rotation correction, 2. Phase reference detection and 3. Phase discontinuity correction.

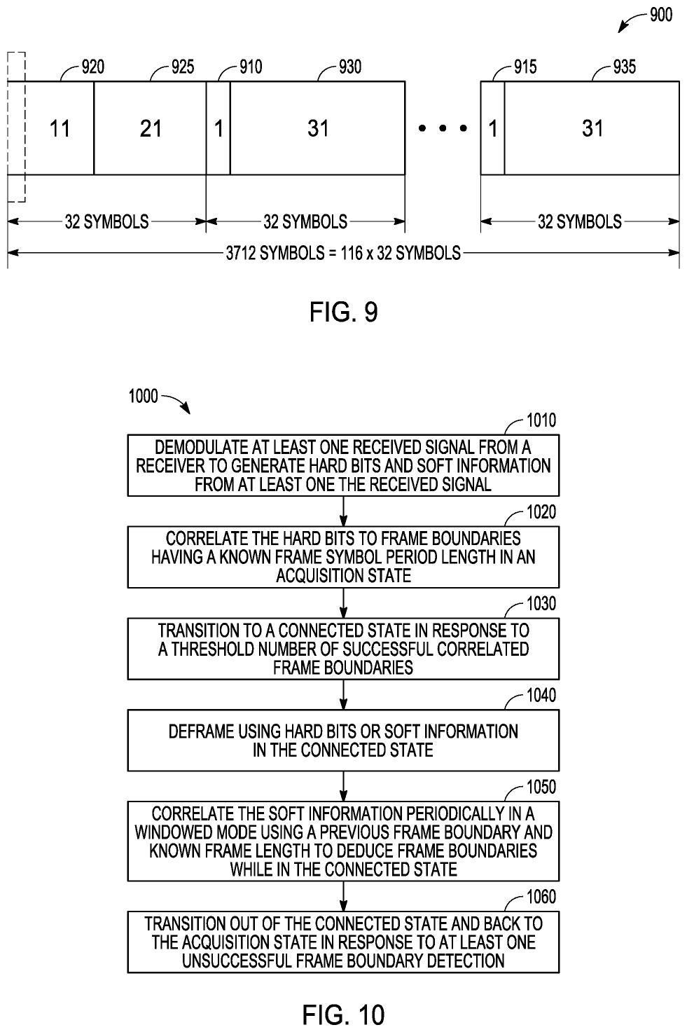

FIG. 9 illustrates an OpenZR subframe structure 900 used to perform cycle slip correction to correct for phase discontinuity. Symbols 910 and 915 denote a pilot sequence. Symbol 920 denotes the training sequence and symbols 925, 930, and 935 denote the frame payload.

### Phase Rotation Correction

Phase rotations in each of the pilot symbols are identified through the following operation, wherein pilot symbols could be present in every P=32 symbols in the received signal. Note that pilot sequence unique to each subframe might be known and is used for this purpose, e.g., 116 symbols in the case of OpenZR. Frame boundary and polarization mapping indices detected by the deframer are used to deduce the location of the pilot symbols in the frame or subframe.

$${P}_{rot \_ x} ( i ) = angle ( {R}_{x} ( i ) {P}_{x} * ( i ) ) i = 1 , 33 , 65 , 97 , …$$

$${P}_{rot \_ y} ( k ) = angle ( {R}_{y} ( k ) {P}_{y} * ( k ) ) k = 1 , 33 , 65 , 97 , …$$

wherein Rₓ(i) and R_{y}(k) denote the received signal on 2 polarizations;
Pₓ*(i) and P_{y}*(k) denote the conjugated pilot sequences on the 2 polarizations;
P_{rot_x}(i) and P_{rot_y}(k) denote the phase rotations calculated at the pilot locations for the 2 polarizations;
x,y denote the polarization mapping indices; i,k denote the indices deduced from the frame boundary

Received symbols at the P=32 symbols nearest to the pilot symbol location are then rotated by this phase offset, through a phase rotation correction circuit. Note that consecutive P=32 symbols are rotated by the same phase offset and they could be either 16 symbols on both sides of the pilot symbol or 32 symbols starting at the pilot symbol location.

$${R}_{rot \_ x} ( m ) = {R}_{x} ( m ) exp ( 1 j {P}_{rot \_ x} ( i ) m = i - 16 : i + 15 ; i = 1 , 33 , 65 , 97 , …$$

$${R}_{rot \_ y} ( n ) = {R}_{y} ( n ) exp ( 1 j {P}_{rot \_ y} ( k ) n = k - 16 : k + 15 ; k = 1 , 33 , 65 , 97 , …$$

Above equations represent the scenario where 16 adjacent samples on either side of the pilot sequence are rotated by the phase rotation value calculated. For the case of 32 symbols starting from the pilot location, m,n indices can be adjusted as m=i:i+31 and n=k:k+31 to represent the phase rotations. This phase rotation helps in removing any phase rotation arising from the photonics IC at the transmitter or the receiver.

### Phase Reference Detection

Phase rotation values are then averaged to establish a phase reference over a subframe or frame duration. This averaging could be based on current or previous subframe and could involve a buffer if previous subframe is used for averaging. Further, modulo of π/2 or π is performed to quantize phase to nearest π/2 or π phase for QPSK and BPSK/DPSK respectively.

$${P}_{ref \_ x} = ( 1 / N ) {\sum }_{i = 1}^{N} {P}_{rot \_ x} ( i ) ; {P}_{ref \_ y} = ( 1 / N ) {\sum }_{i = 1}^{N} {P}_{rot \_ y} ( i )$$

### Phase Discontinuity Correction

Phase discontinuity due to cycle slips lead to incorrect multiples of π/2 in the received signal after phase rotation correction. This is calculated as a phase offset value between the phase rotated symbols in the previous step and the original received signal at the input of the cycle slip. These phase offset values are subtracted from the averaged phase reference value and a programmable threshold is used to deduce the phase discontinuities. For example. π/4, π/2 are suitable thresholds when the modulation scheme is QPSK and BPSK/DPSK respectively. This implies that allowed phase offset with respect to the average phase reference is restricted to π/4 or π/2 and larger values are treated as phase discontinuities and subsequently removed in the cycle slip removal step. Phase differences are first calculated as follows to identify the phase discontinuities.

$${P}_{diff \_ x} ( i ) = angle ( {R}_{rot \_ x} ( i ) {R}_{x} * ( i ) ) - {P}_{ref \_ x}$$

$${P}_{diff \_ y} ( j ) = angle ( {R}_{rot \_ y} ( j ) {R}_{y} * ( j ) ) - {P}_{ref \_ y}$$

Cycle slip removal involves correction of the phase discontinuities when absolute value of P_{diff_x}(i) or P_{diff_y}(j) are above a certain threshold like π/4 or π/2. Only large values of phase differences are used to calculate and correct phase discontinuities, and small phase differences are considered as noisy phase estimates and are not altered. These large phase differences in above equations could be quantized to nearest modulo π/2 or π before removing these phase differences.

For OpenZR/400ZR standards, after performing cycle slip correction, pilot symbols are removed from the LLR stream followed by removal of FAW, reserved and training sequences. In the case of LCRD, SDA standards, which don't involve any cycle slip correction, just the preamble or headers of about 1024 bits maybe removed. Subsequently, FEC payload LLR is fed to descrambler or the FEC engine for Forward error correction.

The de-framer data path to remove various headers and training or pilot sequences could be designed using a CLOS network. CLOS networks are multi-stage switching networks, well known in literature to connect any input with any output, allowing to have 100% of non-blocking utilization if design requirements are met. The de-framer requires this kind of data path to map any input to any output while dropping unnecessary fields or sequences at the output (align header sequences and pilots). Since the network will drop some data, a simplification can be done by using a binary tree decision. To this end, the network configuration will be given by the state machine control that will signal a flag if data shall be propagated to the output, if flag is low then data will be dropped (aligning header and pilots).

FIG. 10 is a flowchart illustrating a method 1000 of deframing symbols according to an example embodiment. Method 1000 begins at operation 1010 by demodulating at least one received signal from a receiver to generate hard bits and soft information from at least one the received signal. Operation 1020 correlates the hard bits to frame boundaries having a known frame symbol period length in an acquisition state. Operation 1030 transitions to a connected state in response to a threshold number of successful correlated frame boundaries. Operation 1040 deframes using hard bits or soft information in the connected state. Operation 1050 correlates the soft information periodically in a windowed mode using a previous frame boundary and known frame length to deduce frame boundaries while in the connected state. Operation 1060 transitions out of the connected state and back to the acquisition state in response to at least one unsuccessful frame boundary detection.

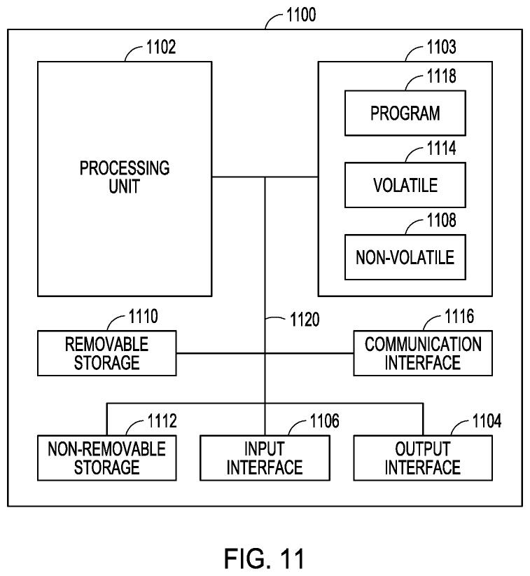

FIG. 11 is a block schematic diagram of a computer system 1100 for use in implementing one or more deframer systems and components within deframer systems, and for performing methods and algorithms according to example embodiments. All components need not be used in various embodiments.

In several aspects, the methods, design and circuitry described are used in Coherent Optical Transceivers built for satellites to enable inter satellite optical links with high data rates of 100 Gbps or beyond.

In some aspects, inter satellite optical links refer to optical communication links between two satellites within the Low earth orbit (LEO) or between a Low earth orbit (LEO) satellite and a Geo-stationary earth orbit (GEO) satellite.

A Coherent optical transceiver may consist of a photonics circuitry, data converters, baseband DSP circuitry, FEC encoder and decoder, and a serial interface. Photonics circuitry is used to convert an electrical signal to an optical signal at the transmitter, and an optical signal to an electrical signal at the receiver. Photonics circuitry may further include a laser source both at the transmitter and the receiver. In coherent optical transceivers, the received optical signal is mixed with a local laser source to decode the signal, that enables both amplitude and phase modulation as well as polarization multiplexing. Data converter circuitry involves a Digital-to-Analog (DAC) converter at the transmitter and an Analog-to-Digital (ADC) converter at the receiver with appropriate sampling rates. Baseband DSP circuitry is used to modulate a signal at the transmitter and demodulate the signal at the receiver based on the waveform, standard and baud rates. Forward error correction (FEC) encoder at the transmitter and FEC decoder at the receiver helps in adding redundancy to reliably decode a bit stream. A serial bit interface is used to format, send or receive the bit stream at the transmitter and the receiver, respectively.

Photonics circuitry may use Mach-Zehnder modulators (MZM) at the transmitter to optically modulate the amplitude and phase based on the modulation scheme. At the transmitter, the photonics circuitry may send the signal either over a single mode fiber (SMF) or a polarization maintaining fiber (PMF) to the optical aperture, which transmits the laser signal over a free space channel. Photonics circuitry may use an Optical front-end with structures called Hybrid 90 at the receiver to mix the received optical signal with a local laser source and generate 4 streams of signals corresponding to the in-phase and quadrature components for the two polarizations. These 4 signals may then be fed to balanced photodiodes for photodetection and amplified further by a Trans-Impedance Amplifier (TIA). ADC circuitry may then convert the analog signal to digital for baseband processing.

Laser source may be tunable in the C-band wavelength range of 1530-1565 nm corresponding to frequency range of roughly 191-196 THz.

Baseband DSP circuitry may support waveforms according to various optical standards such as i) OpenZR+ standard used in fiber optic systems with dual polarization and modulation schemes such as QPSK, 8QAM and 16QAM, ii) NASA developed standard for Lunar Communication Relay Demonstration (LCRD) employing a custom Differential PSK (DPSK) waveform with DVB-S2 FEC, iii) Space Development Agency (SDA) standard with OOK based modulation schemes.

Circuitry (e.g., processing circuitry) is a collection of circuits implemented in tangible entities of the device that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The term “optical system”, as used herein, includes, for example, a device capable for optical communication, by modulating a signal using a laser source or visible light, involving transmission of optical pulses, and may include coherent or direct detection, incorporating photon counting methods or baseband circuitry for signal processing.

One example computing device in the form of a computer 1100 may include a processing unit 1102, memory 1103, removable storage 1110, and non-removable storage 1112. Although the example computing device is illustrated and described as computer 1100, the computing device may be in different forms in different embodiments. For example, the computing device may instead be a smartphone, a tablet, smartwatch, smart storage device (SSD), or other computing device including the same or similar elements as illustrated and described with regard to FIG. 11. Devices, such as smartphones, tablets, and smartwatches, are generally collectively referred to as mobile devices or user equipment.

Although the various data storage elements are illustrated as part of the computer 1100, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1103 may include volatile memory 1114 and non-volatile memory 1108. Computer 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1100 may include or have access to a computing environment that includes input interface 1106, output interface 1104, and a communication interface 1116. Output interface 1104 may include a display device, such as a touchscreen, that also may serve as an input device. The input interface 1106 may include one or more of a touchscreen, touchpad, mouse, keyboard, camera, one or more device-specific buttons, one or more sensors integrated within or coupled via wired or wireless data connections to the computer 1100, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1100 are connected with a system bus 1120.

Computer-readable instructions stored on a computer-readable medium are executable by the processing unit 1102 of the computer 1100, such as a program 1118. The program 1118 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1118 along with the workspace manager 1122 may be used to cause processing unit 1102 to perform one or more methods or algorithms described herein.

### Examples

Example 1 is a system includes a first chiplet that includes at least one demodulator for demodulating at least one received signal from a receiver to generate hard bits and soft information from the received signal and a second chiplet coupled to exchange information with the first chiplet. The second chiplet includes at least one correlator to detect a symbol pattern indicating frame boundaries of frames having a known frame symbol period length in an acquisition state and transitioning the first and second chiplets to a connected state in response to a threshold number of successful frame boundary detections. The at least one correlator uses soft bit representations to correlate and deduce the frame boundaries in a windowed mode using the known frame length and previous frame boundary information while in the connected state and transitions the first and second chiplets out of the connected state and back to the acquisition state in response to at least one unsuccessful frame boundary detection.

Example 2 includes the system of example 1 and wherein the first and second chiplets are configured to exchange at least one of symbol information, frame boundary, polarization mapping, symbol counter state to synchronize the chiplets, gating locations for supporting burst mode waveforms information.

Example 3 includes the system of any of examples 1-2 wherein the at least one correlator combines a plurality of frame-symbol length separated correlation output values to improve correlator performance in the presence fading or low signal to noise (SNR) conditions.

Example 4 includes the system of any of examples 1-3 wherein frame deframing enters a flywheel mode in low SNR conditions and wherein a past frame boundary deduced at high SNR conditions is used to select frame boundary positions using the known frame length; once SNR conditions improve above a threshold enables a resumption to a normal connected state.

Example 5 includes the system of any of examples 1-4 wherein frame boundary correlator is configured to performing a triangle detection with a peak and a plurality of side thresholds on correlator output values.

Example 6 includes the system of example 5 wherein a positive frame boundary detection uses a triangle detection to determine that a correlator output value is above a peak threshold and that a plurality of adjacent correlator output values are below a plurality of side thresholds.

Example 7 includes the system of any of examples 1-6 wherein at least one frame length and at least one correlation sequence is configurable to different optical transmission protocols.

Example 8 includes the system of any of examples 1-7 wherein at least one frame correlator performs correlation in the connected state by using either hard bits or soft information such as Log likelihood Ratio (LLR) and the frame correlator periodicity is set to the frame length and programmable window is chosen as 7, 9 or 11 consecutive symbol locations.

Example 9 includes the system of any of examples 1-8 wherein the received signal is modulated using a non-differential scheme comprising at least one of binary or quadrature phase shift keying (BPSK or QPSK), wherein the first chiplet performs cycle slip correction which comprises a phase corrector to perform phase correction in the connected state, an averaging filter to average and establish a phase reference, and then estimates and removes phase discontinuities in the received signal.

Example 10 includes the system of example 9 wherein the phase corrector is configured to deduce locations of pilot symbols and frame payloads in a frame, determine phase rotations at the pilot symbol locations, and rotate the frame payloads based on the phase rotations.

Example 11 is method includes demodulating at least one received signal from a receiver to generate hard bits and soft information from at least one the received signal, correlating the hard bits to frame boundaries having a known frame symbol period length in an acquisition state, transitioning to a connected state in response to a threshold number of successful correlated frame boundaries, deframing using hard bits or soft information in the connected state, correlating the soft information periodically in a windowed mode using a previous frame boundary and known frame length to deduce frame boundaries while in the connected state, and transitioning out of the connected state and back to the acquisition state in response to at least one unsuccessful frame boundary detection.

Example 12 includes the method of example 11 wherein correlating hard bits or soft information to deduce the frame boundaries is performed in a first chiplet and deframing to deduce frame boundaries in the connected state is performed in a second chiplet.

Example 13 includes the method of example 12 and further including synchronizing the first and second chiplets by sharing at least one of frame boundary, polarization mapping and symbol counter information, along with gating locations for supporting received signals from burst mode waveforms.

Example 14 includes the method of any of examples 11-13 wherein frame correlation involves combining a plurality of correlation output values for a programmable window length and estimating a best frame boundary candidate, to improve deframing performance in fading or low signal to noise (SNR) conditions

Example 15 includes the method of any of examples 11-14 wherein frame correlation is performed in a flywheel state wherein generation of correlation output values are avoided in fading or low SNR conditions and past frame boundary estimates are used at high SNR to predict future frame boundary and by using the known frame length; once SNR conditions improve above a threshold enables a resumption to a normal connected state.

Example 16 includes the method of any of examples 11-15 wherein frame boundary candidates are identified using a triangle detection that includes detecting a peak and a plurality of side thresholds about deduced frame boundaries.

Example 17 includes the method of any of examples 11-16 wherein a positive frame boundary detection using a triangle detection includes determining that a correlator output value is above a peak threshold and that a plurality of adjacent correlator output values are below a plurality of side thresholds.

Example 18 includes the method of example 17 and further including populating a lookup table with frame boundary candidates and a corresponding number of successive detected frame boundaries.

Example 19 includes the method of any of examples 11-18 wherein hard bits are correlated with a known sequence in the acquisition state using bit exclusive or operations (bit xor) and soft information are correlated with a known sequence in the connected state using adders involving a sign of the sequence, or by using a variant of an approximate Massey algorithm using an absolute value of the soft information.

Example 20 includes the method of any of examples 11-19 wherein correlation to deduce frame boundaries in the connected state uses either hard bits or soft information such as Log likelihood Ratio (LLR); and correlator periodicity is set to the frame length and programmable window is chosen as 7 or 11 consecutive symbol locations.

Example 21 includes the method of any of examples 11-20 wherein hard bits are correlated with a known sequence in the acquisition state using bit exclusive or operations (bit xor) and soft information are correlated with a known sequence in the connected state using adders involving a sign of the sequence, or by using a variant of an approximate Massey algorithm using an absolute value of the soft information.

Example 22 includes the method of any of examples 11-22 wherein the received digital signal is modulated using non-differential scheme such as phase shift keying (BPSK or QPSK), the method further involves cycle slip correction which comprises of phase correction in the connected state, an averaging step to establish a phase reference and then use it to handle phase discontinuities in the signal.

Example 23 includes the method of example 22 wherein performing phase correction includes deducing locations of pilot symbols and frame payloads in a frame, determining phase rotations at the pilot symbol locations, and rotating the frame payloads based on the phase rotations.

Example 24 includes the method of example 23 and further including performing cycle slip correction in the connected state to remove phase discontinuities in response to an absolute value of phase differences being above a programmable threshold.

Example 25 is a machine-readable storage device has instructions for execution by a processor of a machine to cause the processor to perform operations to perform a method, the operations including demodulating at least one received signal from a receiver to generate hard bits and soft information from at least one the received signal, correlating the hard bits to frame boundaries have a known frame symbol period length in an acquisition state, transitioning to a connected state in response to a threshold number of successful correlated frame boundaries, deframing using hard bits or soft information in the connected state, correlating the soft information periodically in a windowed mode using a previous frame boundary and known frame length to deduce frame boundaries while in the connected state, and transitioning out of the connected state and back to the acquisition state in response to at least one unsuccessful frame boundary detection.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

Skilled artisans will appreciate that while the embodiments described herein are described with respect to a coherent optical transceiver, the concepts can be applied to other transceivers such as wireless, wireline, or direct-detection optical transceivers.

1. A system comprising:
a first chiplet comprising:
at least one demodulator for demodulating at least one received signal from a receiver to generate hard bits and soft information from the received signal; and
a second chiplet coupled to exchange information with the first chiplet, the second chiplet comprising:
at least one correlator to detect a symbol pattern indicating frame boundaries of frames having a known frame symbol period length in an acquisition state and transitioning the first and second chiplets to a connected state in response to a threshold number of successful frame boundary detections;
wherein the at least one correlator uses soft bit representations to correlate and deduce the frame boundaries in a windowed mode using the known frame length and previous frame boundary information while in the connected state and transitions the first and second chiplets out of the connected state and back to the acquisition state in response to at least one unsuccessful frame boundary detection.

2. The system of claim 1 and wherein the first and second chiplets are configured to exchange at least one of symbol information, frame boundary, polarization mapping, symbol counter state to synchronize the chiplets, gating locations for supporting burst mode waveforms information.

3. The system of claim 1 wherein the at least one correlator combines a plurality of frame-symbol length separated correlation output values to improve correlator performance in the presence fading or low signal to noise (SNR) conditions.

4. The system of claim 1 wherein frame deframing enters a flywheel mode in low SNR conditions and wherein a past frame boundary deduced at high SNR conditions is used to select frame boundary positions using the known frame length once SNR conditions improve above a threshold enables a resumption to a normal connected state.

5. The system of claim 1 wherein frame boundary correlator is configured to performing a triangle detection with a peak and a plurality of side thresholds on correlator output values, and wherein a positive frame boundary detection uses a triangle detection to determine that a correlator output value is above a peak threshold and that a plurality of adjacent correlator output values are below a plurality of side thresholds.

6. The system of claim 1 wherein at least one frame length and at least one correlation sequence is configurable to different optical transmission protocols.

7. The system of claim 1 wherein at least one frame correlator performs correlation in the connected state by using either hard bits or soft information such as Log likelihood Ratio (LLR) and the frame correlator periodicity is set to the frame length and programmable window is chosen as 7, 9 or 11 consecutive symbol locations.

8. The system of claim 1 wherein the received signal is modulated using a non-differential scheme comprising at least one of binary or quadrature phase shift keying (BPSK or QPSK), wherein the first chiplet performs cycle slip correction which comprises a phase corrector to perform phase correction in the connected state, an averaging filter to average and establish a phase reference, and then estimates and removes phase discontinuities in the received signal.

9. The system of claim 8 wherein the phase corrector is configured to deduce locations of pilot symbols and frame payloads in a frame, determine phase rotations at the pilot symbol locations, and rotate the frame payloads based on the phase rotations.

10. A method comprising:
demodulating at least one received signal from a receiver to generate hard bits and soft information from at least one the received signal;
correlating the hard bits to frame boundaries having a known frame symbol period length in an acquisition state;
transitioning to a connected state in response to a threshold number of successful correlated frame boundaries;
deframing using hard bits or soft information in the connected state;
correlating the soft information periodically in a windowed mode using a previous frame boundary and known frame length to deduce frame boundaries while in the connected state; and
transitioning out of the connected state and back to the acquisition state in response to at least one unsuccessful frame boundary detection.

11. The method of claim 10 wherein correlating hard bits or soft information to deduce the frame boundaries is performed in a first chiplet and deframing to deduce frame boundaries in the connected state is performed in a second chiplet.

12. The method of claim 11 and further comprising synchronizing the first and second chiplets by sharing at least one of frame boundary, polarization mapping and symbol counter information, along with gating locations for supporting received signals from burst mode waveforms.

13. The method of claim 10 wherein frame correlation involves combining a plurality of correlation output values for a programmable window length and estimating a best frame boundary candidate, to improve deframing performance in fading or low signal to noise (SNR) conditions.

14. The method of claim 10 wherein frame correlation is performed in a flywheel state wherein generation of correlation output values are avoided in fading or low SNR conditions and past frame boundary estimates are used at high SNR to predict future frame boundary and by using the known frame length; once SNR conditions improve above a threshold enables a resumption to a normal connected state.

15. The method of claim 10 wherein frame boundary candidates are identified using a triangle detection that comprises detecting a peak and a plurality of side thresholds about deduced frame boundaries.

16. The method of claim 10 wherein a positive frame boundary detection using a triangle detection comprises determining that a correlator output value is above a peak threshold and that a plurality of adjacent correlator output values are below a plurality of side thresholds.

17. The method of claim 16 and further comprising populating a lookup table with frame boundary candidates and a corresponding number of successive detected frame boundaries.

18. The method of claim 10 wherein hard bits are correlated with a known sequence in the acquisition state using bit exclusive or operations (bit xor) and soft information are correlated with a known sequence in the connected state using adders involving a sign of the sequence, or by using a variant of an approximate Massey algorithm using an absolute value of the soft information.

19. A machine-readable storage device having instructions for execution by a processor of a machine to cause the processor to perform operations to perform a method, the operations comprising:
demodulating at least one received signal from a receiver to generate hard bits and soft information from at least one the received signal;
correlating the hard bits to frame boundaries have a known frame symbol period length in an acquisition state;
transitioning to a connected state in response to a threshold number of successful correlated frame boundaries;
deframing using hard bits or soft information in the connected state;
correlating the soft information periodically in a windowed mode using a previous frame boundary and known frame length to deduce frame boundaries while in the connected state; and
transitioning out of the connected state and back to the acquisition state in response to at least one unsuccessful frame boundary detection.

20. The device of claim 19 wherein hard bits are correlated with a known sequence in the acquisition state using bit exclusive or operations (bit xor) and soft information are correlated with a known sequence in the connected state using adders involving a sign of the sequence, or by using a variant of an approximate Massey algorithm using an absolute value of the soft information.
